(19) United States
(12) Patent Application Publication
(10) Pub. No.: US 2012/0304129 A1
(43) Pub. Date: Nov. 29, 2012

(54) ONLINE JEWELRY CONFIGURATION APPLICATION

(76) Inventor: Daniella De Francesco, Miami, FL (US)

(21) Appl. No.: 13/483,030

(22) Filed: May 29, 2012

Related U.S. Application Data
(60) Provisional application No. 61/490,574, filed on May 26, 2011.

(51) Int. Cl. G06F 3/048

(52) U.S. Cl. 715/849

(57) ABSTRACT

A method on a server for providing jewelry configuration processes over a communications network is disclosed. The method includes providing a graphical user interface to a user over the communications network, receiving, via the graphical user interface, jewelry customizations from the user, generating, in real-time, a three-dimensional representation of a piece of jewelry based on the jewelry customizations that were received, rendering, in real-time, the three-dimensional representation of the piece of jewelry that was generated and displaying in the graphical user interface the three-dimensional representation of the piece of jewelry that was rendered.

### CROSS-REFERENCE TO RELATED APPLICATIONS

This utility patent application claims priority to provisional application No. 61/490,574 entitled “Online Jewelry Configuration Application,” filed May 26, 2011. The subject matter of provisional application No. 61/490,574 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND OF THE INVENTION

1. Field of the Invention

The present invention relates to the field of e-commerce and, more specifically, the present invention relates to the field of sharing and selling of media content over a communications network.

2. Description of the Related Art

Consumers typically enjoy seeing a product—or better yet, touch and feel a product—before purchase. It is customary that consumers will browse products and “kick the tires,” so to speak, before making buying decisions. But the advent of online commerce has reduced a consumer's ability to see, touch and feel a product before purchase. Nowhere in the consumer spending sector is this more palpable than in the jewelry industry. Due to the potentially high costs of jewelry, and the everyday use of jewelry on individual's bodies, consumers have an amplified desire to know exactly what a piece of jewelry will look like before the consumer commits to the product.

One approach to this problem is the availability of “build your own” tools on commercial jewelry web sites that allows a consumer to design his own jewelry and view it. The currently available approaches, however, provide very low resolution images of the jewelry being built and typically only provide two-dimensional images. This solution lacks the higher-fidelity, higher-resolution and multiple point-of-view presentation that consumers desire.

Therefore, what is needed is a system and method for improving the problems with the prior art, and more particularly for a higher-resolution or higher-fidelity method and system for building and viewing jewelry over a communications network.

### BRIEF SUMMARY OF THE INVENTION

Embodiments of the present invention address deficiencies of the art in respect to e-commerce and provide a novel and non-obvious method for customizing jewelry online. In an embodiment of the invention, a method on a server for providing jewelry configuration processes over a communications network is disclosed. The method includes providing a graphical user interface to a user over the communications network, receiving, via the graphical user interface, jewelry customizations from the user, generating, in real-time, a three-dimensional representation of a piece of jewelry based on the jewelry customizations that were received, rendering, in real-time, the three-dimensional representation of the piece of jewelry that was generated and displaying in the graphical user interface the three-dimensional representation of the piece of jewelry that was rendered.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture of a system for providing jewelry configuration processes over a communications network, in accordance with one embodiment of the present invention.

FIGS. 2-1 to 2-22 are screenshots of an online interface for providing jewelry configuration processes over a communications network, in accordance with one embodiment of the present invention.

### DETAILED DESCRIPTION OF THE INVENTION

The present invention improves upon the problems with the prior art by providing a higher-resolution and higher-fidelity system for allowing users to customize and visualize jewelry over a communications network such as the Internet. In one embodiment, the present invention allows a consumer to visit an online site that allows him or her to customize and build a piece of jewelry, such as a ring. The present invention generates high-resolution three-dimensional CAD models of the ring in real-time, or on-the-fly, as the user makes selections to build the ring. Further, the present invention immediately generates and displays three-dimensional renderings of the ring, which are displayed for the user in customizable points of views from varying angles. Three-dimensional rotation and zooming of the ring are additional features provided to the user.

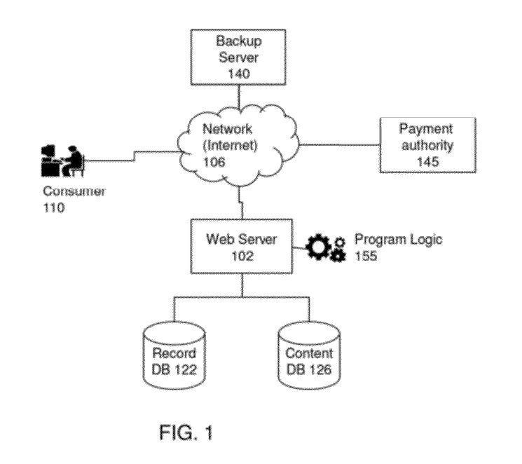

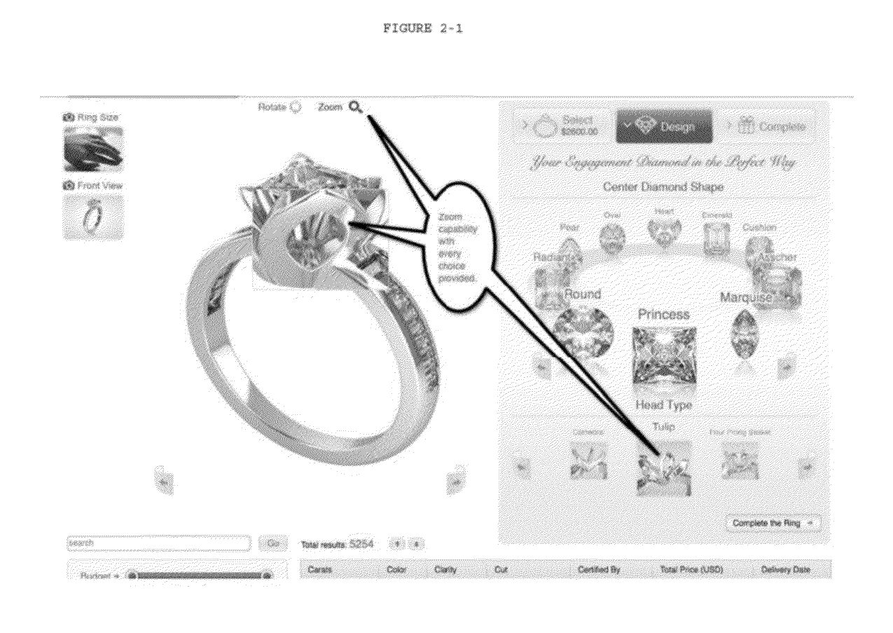

Referring now to the drawing figures in which like reference designators refer to like elements, there is shown in FIG. 1 an illustration of a block diagram showing the network architecture of a software application in accordance with the principles of the present invention. FIG. 1 shows an embodiment of the present invention wherein a consumer 110, comprising a user and a computer, interacts with web server 102 over a network 106, which can be a packet switched network such as the Internet or the World Wide Web. The computer of consumer 110 can be a desktop, a laptop, handheld computer, a smart phone, a tablet computer or the like.

Web server 102 includes a software engine that delivers files, applications, image files, music files, video files, app files, machine readable code and other media content to consumer 110. The software engine of server 102 may perform other media content delivering processes such as video streaming or any other standard for transferring multimedia data in a stream of packets that are interpreted and rendered, in real time, by a software application as the packets arrive. It should be noted that although FIG. 1 shows only one consumer 110 and one web server 102, the system of the present invention supports any number of client users and web servers connected via network 106.

Server 102 includes program logic 155 comprising computer source code, scripting language code or interpreted language code that is compiled to produce computer instructions that perform various functions of the present invention. In one embodiment of the present invention, the program logic is a scripting language such as ECMAScript, CSS, XML (Extensible Markup Language), XSLT (Extensible Style-sheet Language Transformations), Javascript, AJAX (Asynchronous JavaScript and XML), XUL, JSP, PHP, and ASP (Active Server Pages). Program logic 155 may reside on a client computer, the server 102 or any combination of the two.

In one embodiment of the present invention, the network application provided by the web server 102 of FIG. 1 (i.e., program logic 155) is a client-server application having a client portion that resides on client computer 110 and a server application that resides on web server 102. For example, the network application can be a web interface that is accessed by client computer 110 via network 106. In another embodiment of the present invention, the web server 120 delivers to client 110 an application having only a client portion that resides on client computer 110. For example, the application can be a web browser extension or web browser add-on, which is an installable enhancement to a web browser. The web browser extension or web browser add-on may be written using any of the following technologies: CSS (Cascading Style Sheets), DOM (Document Object Model), JavaScript, XPCOM (Cross-Platform Component Object Model), XPConnect, XPI (Cross-Platform Installer), XUL (XML User Interface

Language).

FIG. 1 further shows that web server 102 is connected to a record database 122, and a media content database 126. Database 122 is used to store records, such as profiles and consumer account data, which have been created for each user 110. Database 126 stores all media content associated with jewelry, such as still images, three dimensional data, CAD models, audio data, movie data, app data, etc.

FIG. 1 also shows a payment authority 145 to effectuate payments by consumers 112 for jewelry purchased from the business operating server 102. In one embodiment of the present invention, the payment authority 145 is a payment gateway, which is an e-commerce Application Service Provider (ASP) service that authorizes payments for e-businesses, online retailers, or traditional brick and mortar businesses. A payment gateway is the equivalent of a physical point-of-sale terminal located in most retail outlets. Payment gateways encrypt sensitive information, such as credit card numbers, to ensure that information passes securely between the customer and the merchant. A payment gateway facilitates the transfer of information between a payment portal (such as a website) and the acquiring bank, quickly and securely. When a customer orders a product or service from a payment gateway enabled merchant, the payment gateway performs a variety of tasks to process the transaction. Payment gateways accept payment via the use of credit cards, charge cards, bank cards, gift cards, account cards, etc.

Lastly, FIG. 1 shows a backup server 140 which makes copies of data on server 102 and/or its associated databases, so that these additional copies may be used to restore the original after a data loss event. The backup server 140 may be used to restore a state following a disaster or to restore small numbers of files after they have been accidentally deleted or corrupted.

Note that although server 102 is shown as a single and independent entity, in one embodiment of the present invention, the functions of server 102 may be integrated with the functions of another entity, such as entities 140 and 145 of FIG. 1. Further server 102 and its functionality, according to a preferred embodiment of the present invention, can be realized in a centralized fashion in one computer system, or in a distributed fashion where different elements are spread across several interconnected computer systems.

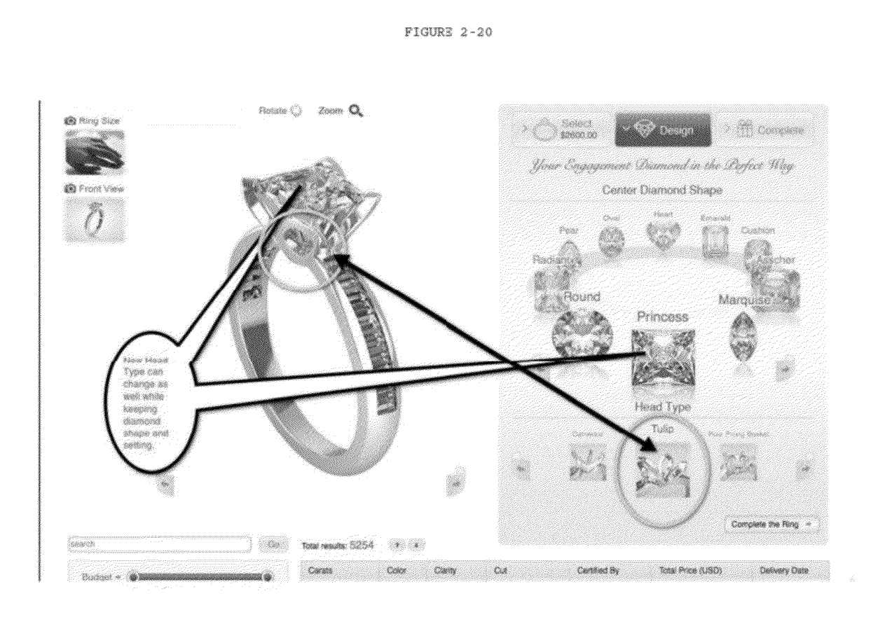

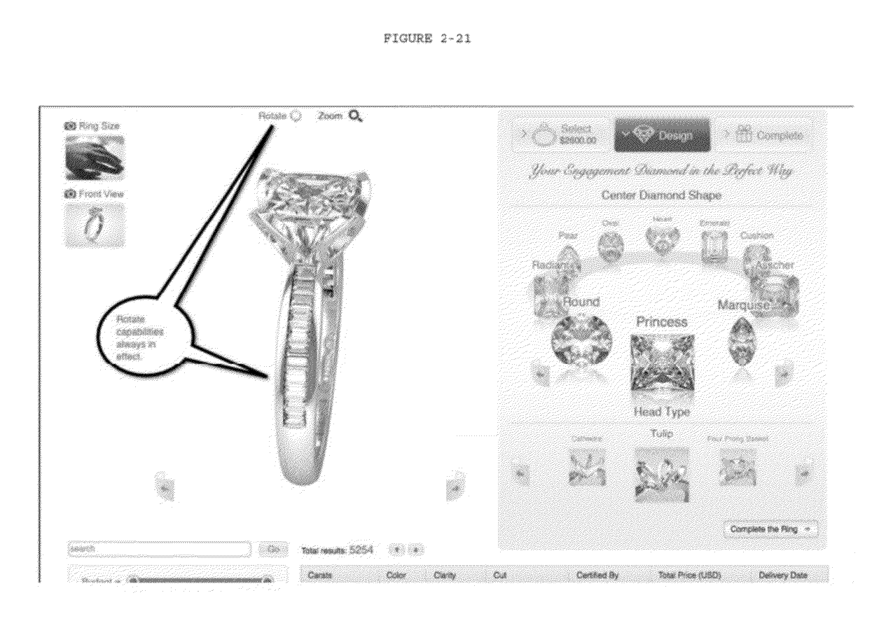

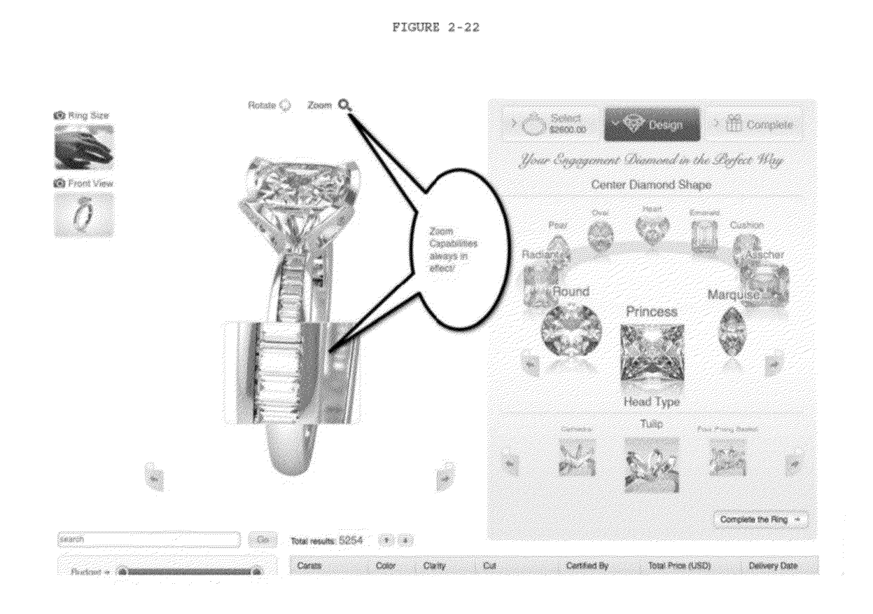

FIGS. 2-1 to 2-22 are screenshots of an online interface for providing jewelry configuration processes over a communications network, in accordance with one embodiment of the present invention. The following FIGS. 2-1 to 2-22 show interfaces provided by server 102 during the jewelry configuration process.

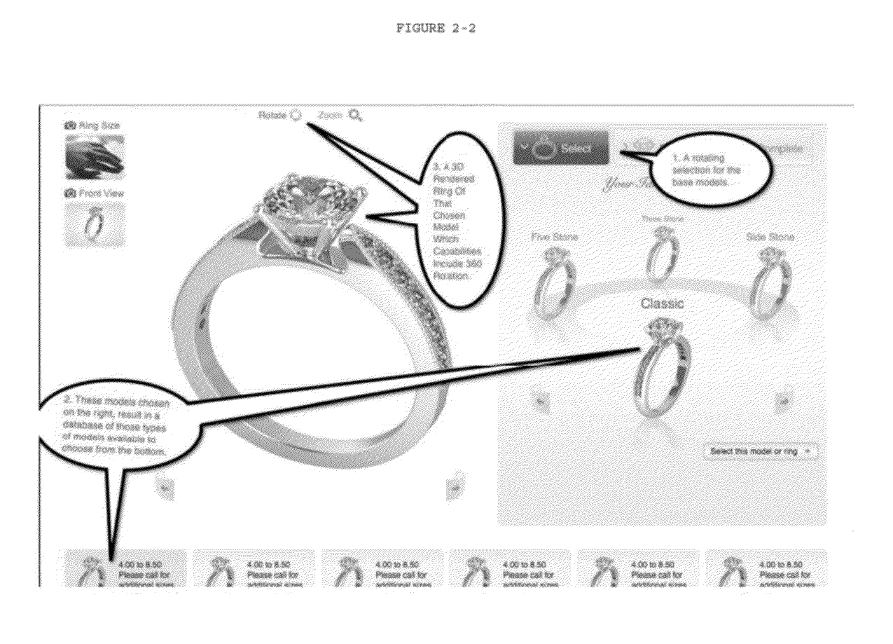

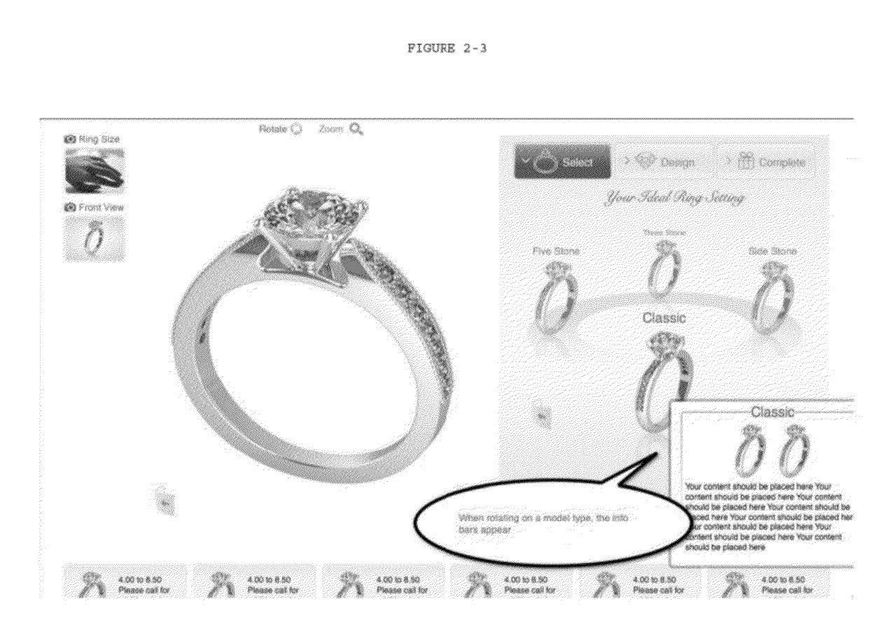

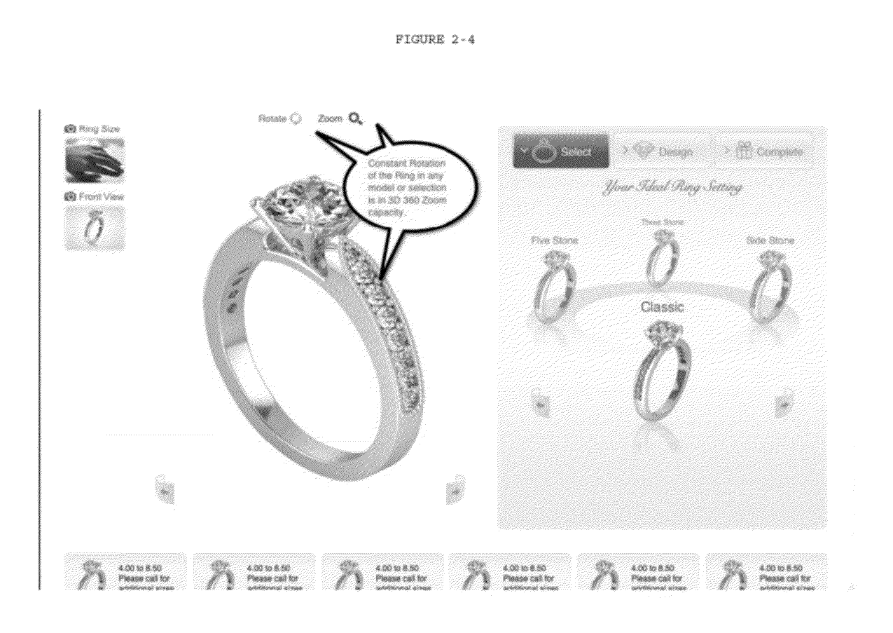

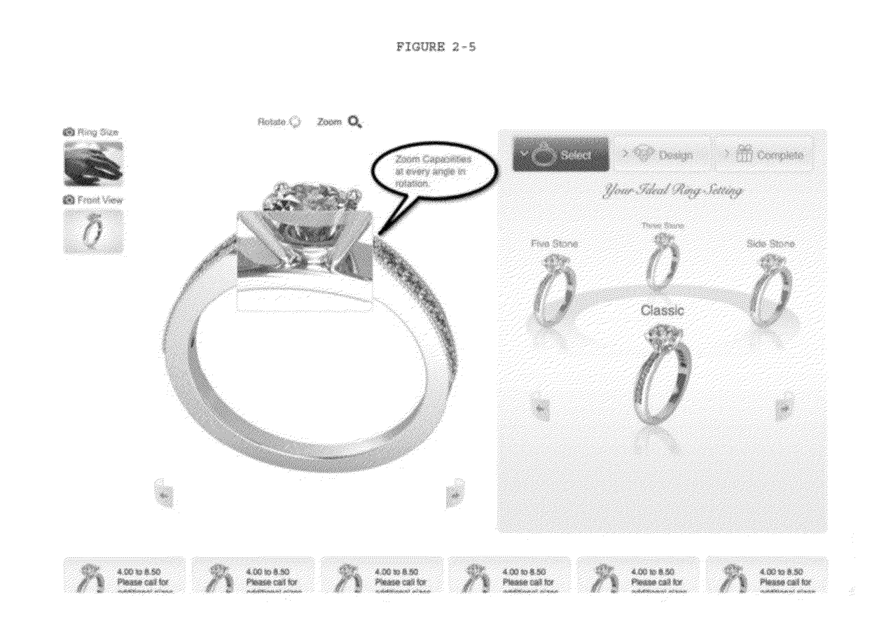

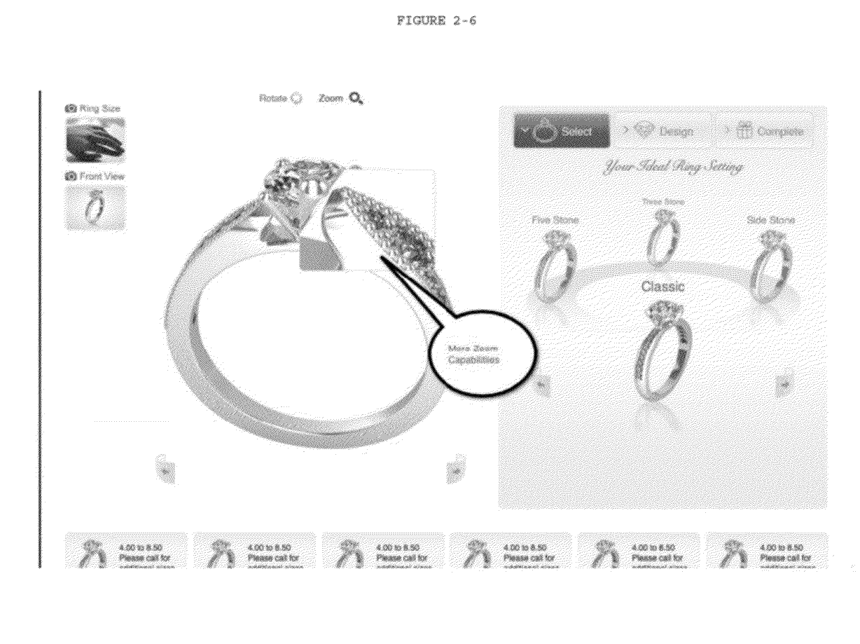

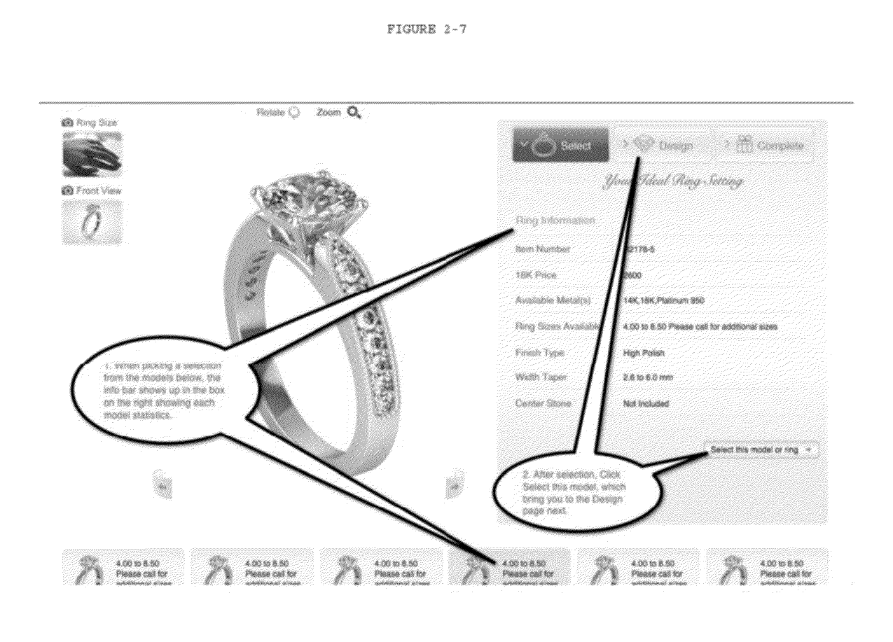

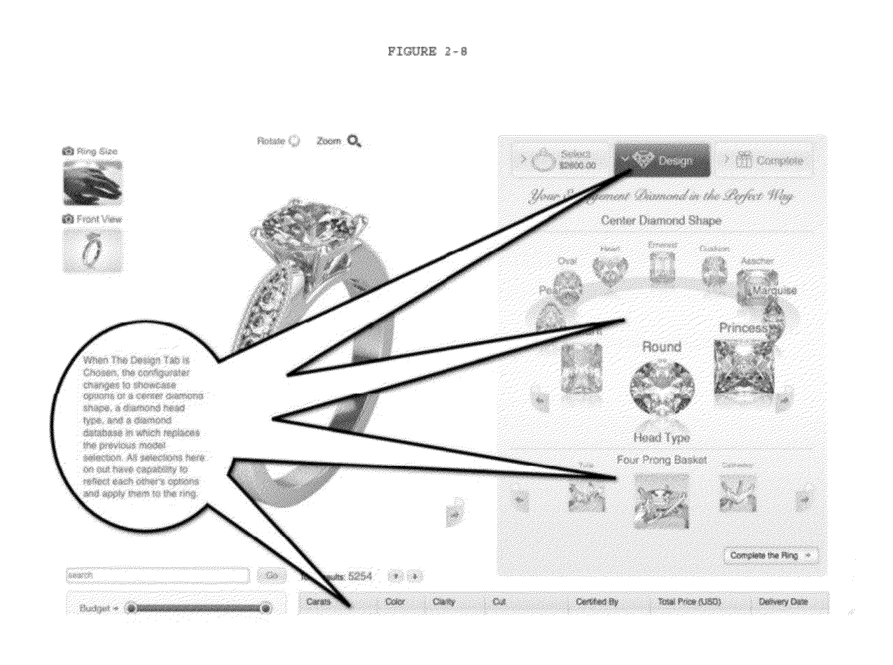

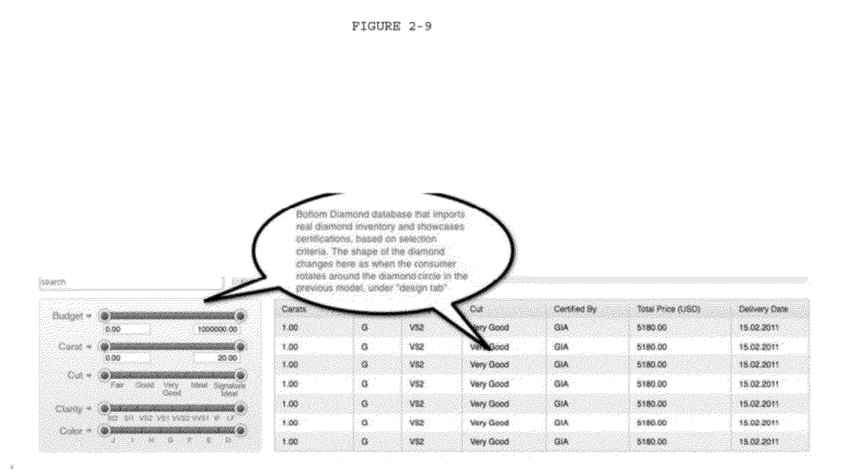

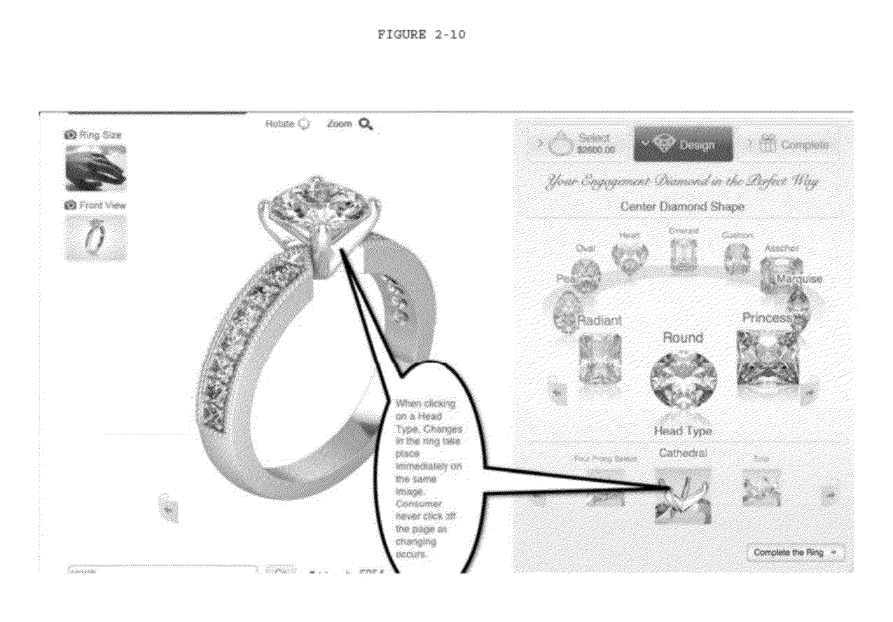

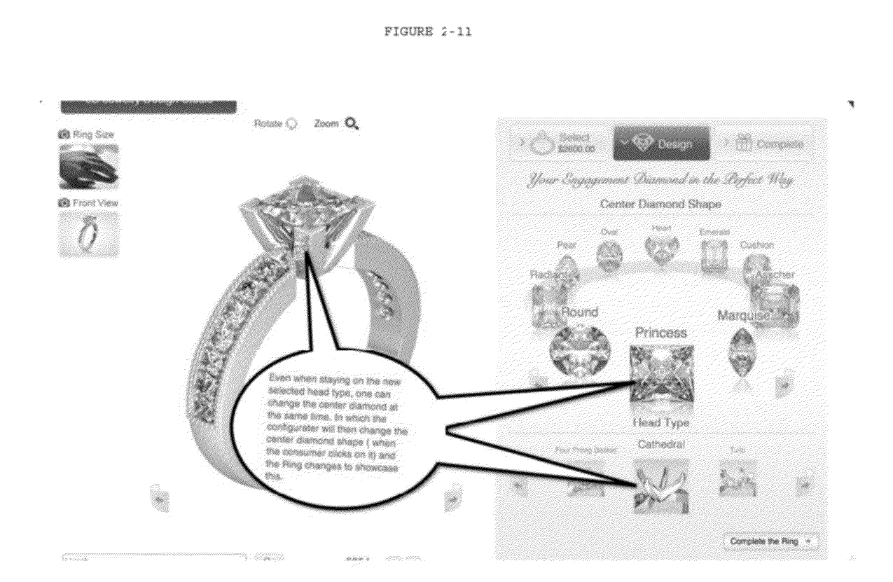

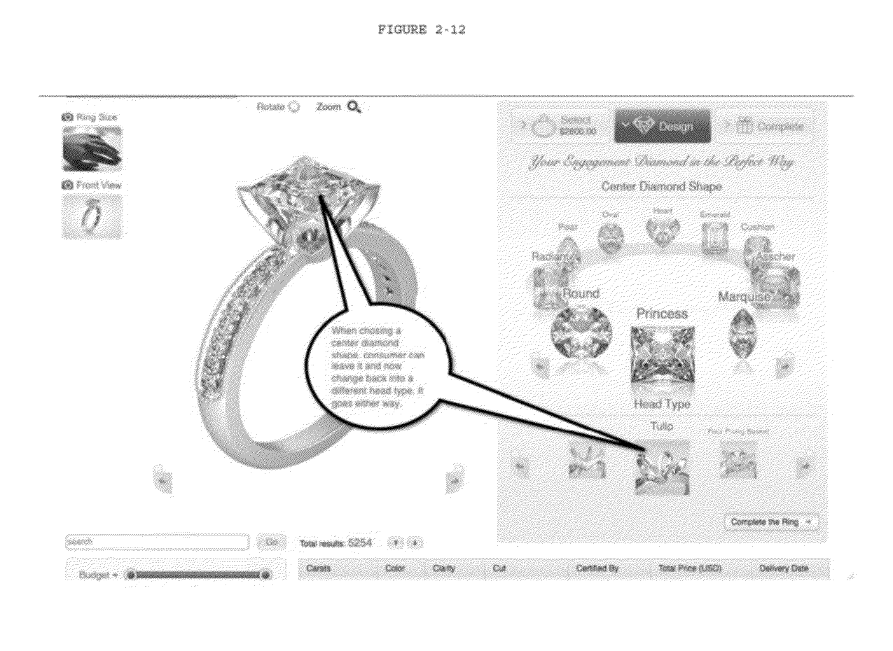

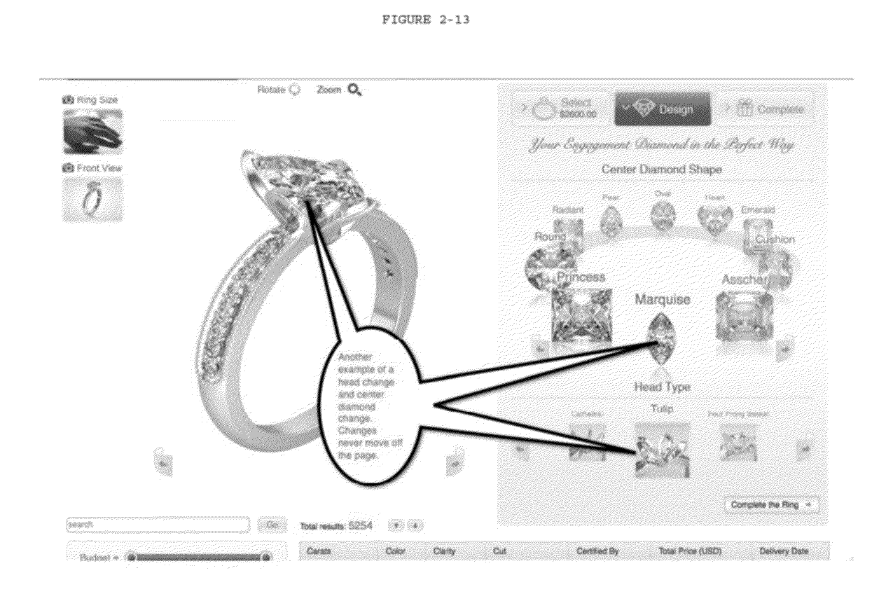

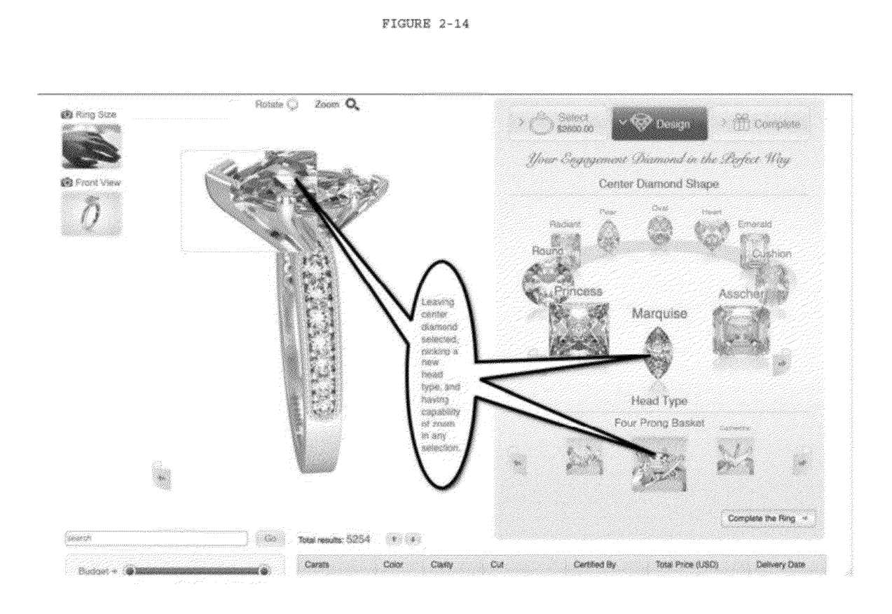

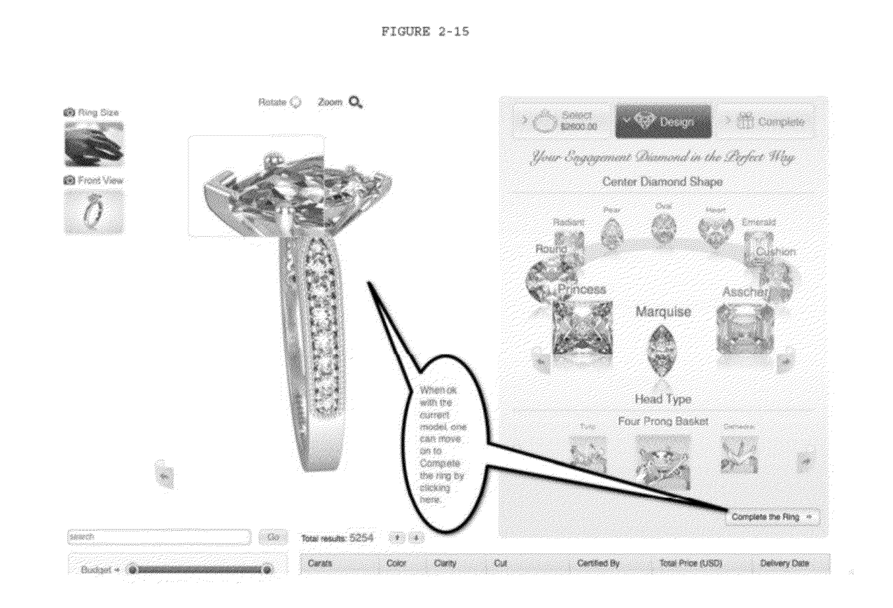

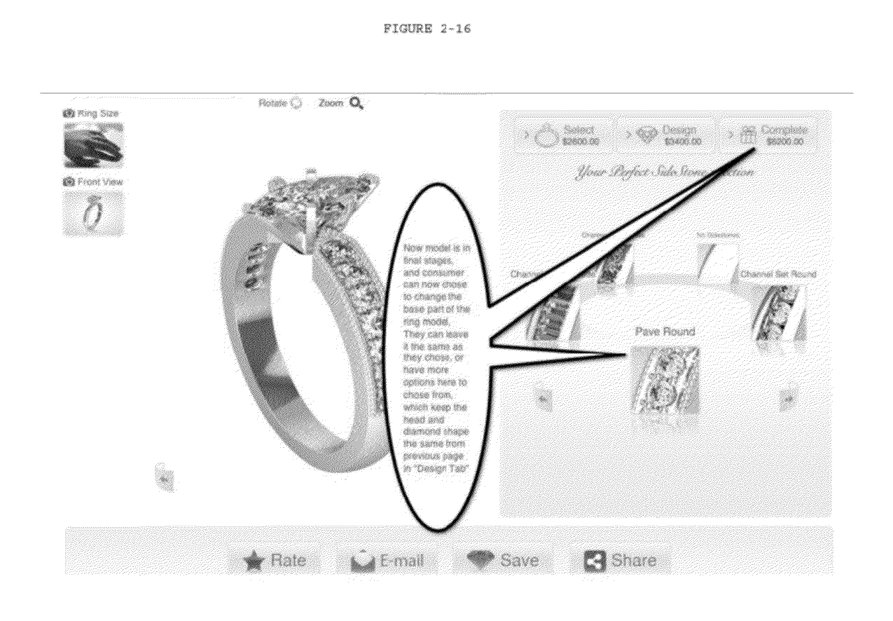

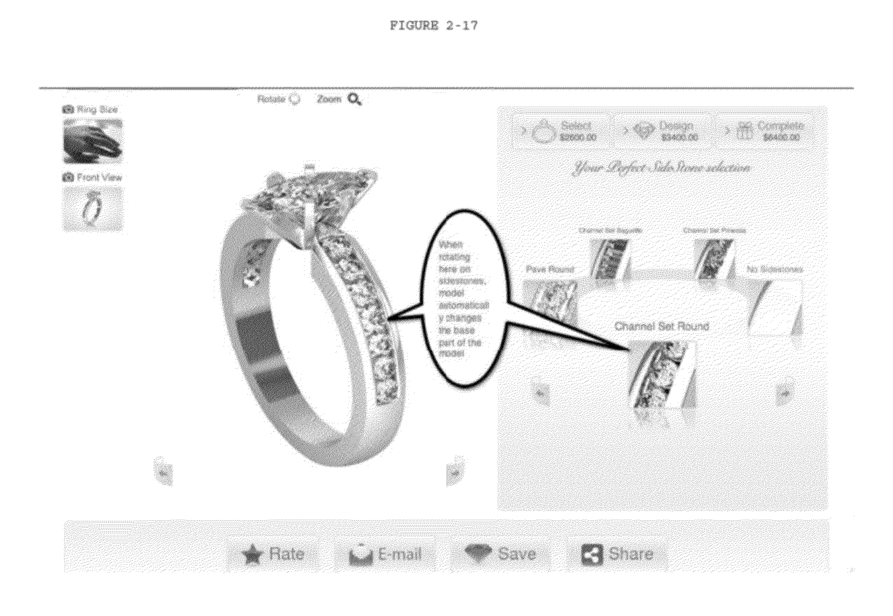

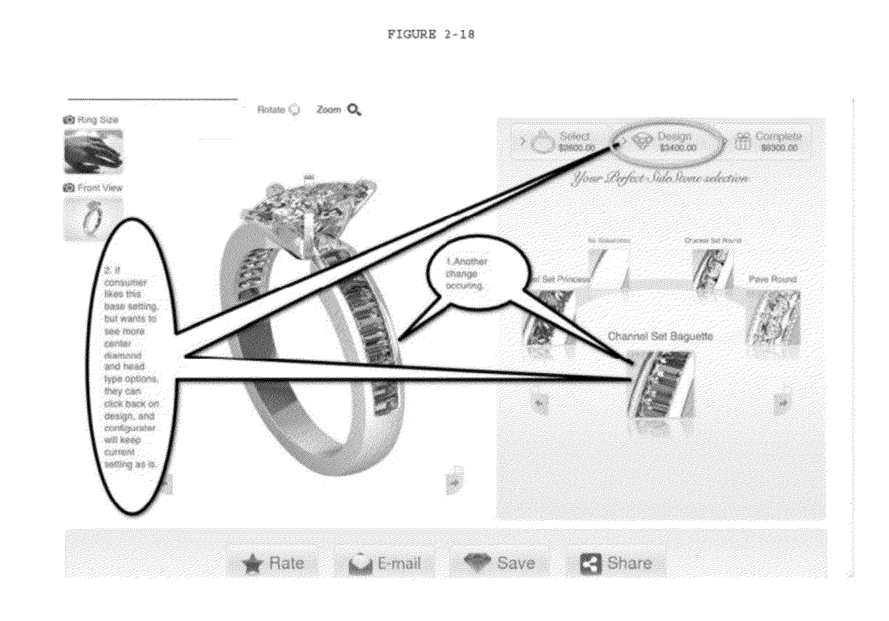

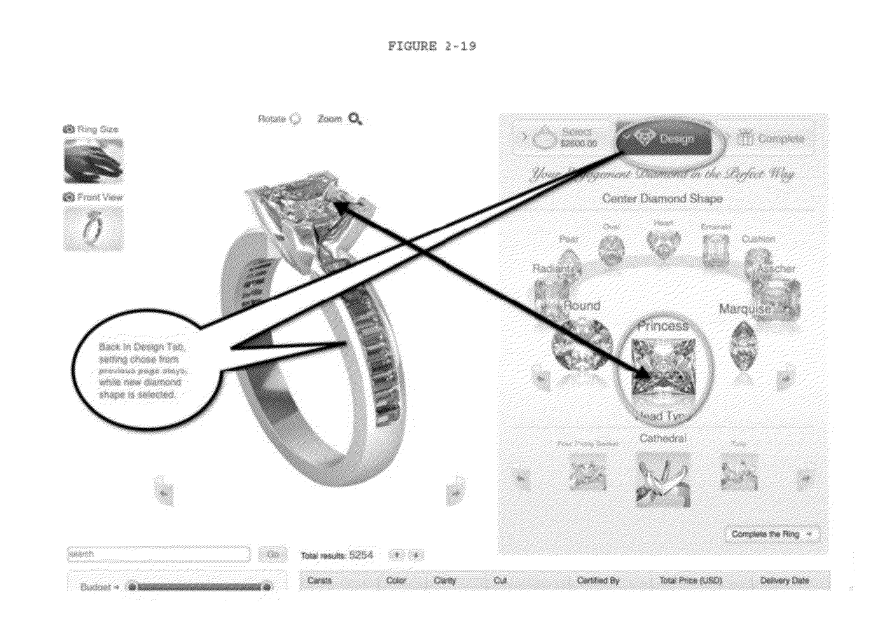

FIG. 2-1 shows an interface depicting a high-resolution, three-dimensional CAD model of a ring that has been rendered in real-time according to a user's selections of customizations. The figure shows that zoom capability is available for the rendered ring (also see FIGS. 2-5, 2-6 and 2-22). FIGS. 2-2 and 2-4 (also see FIG. 2-21) show that a rotation feature is available for the rendered ring. FIG. 2-3 shows that information about a rendered ring can be displayed in an overlaid window. FIGS. 2-7, 2-8 show that clicking on certain selections brings up other options or windows that provide further sub-options. As additional selections are made for the customizations of the ring, a high-resolution, three-dimensional model of the newly defined ring is generated and rendered in the interface (see FIGS. 2-10 through 2-14 and FIGS. 2-19 through 2-20).

FIG. 2-9 shows a selection of diamonds that may be selected for inclusion in the user's ring. FIGS. 2-15 through 2-18 show the final stages of customization of the ring, including choosing channels and side stones.

The present invention can be realized in hardware, software, or a combination of hardware and software in the system described in the figures above. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits.

In this document, the terms “computer program medium,” “computer usable medium,” and “computer readable medium” are used to generally refer to media such as main memory removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method on a server for providing jewelry configuration processes over a communications network, comprising:
providing a graphical user interface to a user over the communications network;
receiving, via the graphical user interface, jewelry customizations from the user;
generating, in real-time, a three-dimensional representation of a piece of jewelry based on the jewelry customizations that were received;
rendering, in real-time, the three-dimensional representation of the piece of jewelry that was generated; and
displaying in the graphical user interface the three-dimensional representation of the piece of jewelry that was rendered.

2. The method of claim 1, further comprising:
receiving, via the graphical user interface, additional jewelry customizations from the user;
generating, in real-time, a three-dimensional representation of the piece of jewelry based on the additional jewelry customizations that were received;
rendering, in real-time, the three-dimensional representation of the piece of jewelry that was generated; and
displaying in the graphical user interface the three-dimensional representation of the piece of jewelry that was rendered.

3. The method of claim 1, wherein a jewelry customization comprises:
a base model of jewelry, a stone shape, a setting selection, a head type or a channel type.

4. The method of claim 1, further comprising:
receiving, via the graphical user interface, a rotate or zoom command from the user;
generating, in real-time, a three-dimensional representation of a piece of jewelry based on the rotate or zoom command that was received;
rendering, in real-time, the three-dimensional representation of the piece of jewelry that was generated; and
displaying in the graphical user interface the three-dimensional representation of the piece of jewelry that was rendered.

5. A computer program product comprising a computer usable medium embodying computer usable program code for providing jewelry configuration processes over a communications network, comprising:
computer usable program code for providing a graphical user interface to a user over the communications network;
computer usable program code for receiving, via the graphical user interface, jewelry customizations from the user;
computer usable program code for generating, in real-time, a three-dimensional representation of a piece of jewelry based on the jewelry customizations that were received;
computer usable program code for rendering, in real-time, the three-dimensional representation of the piece of jewelry that was generated; and
computer usable program code for displaying in the graphical user interface the three-dimensional representation of the piece of jewelry that was rendered.

6. The computer program product comprising of claim 5, further comprising:
computer usable program code for receiving, via the graphical user interface, additional jewelry customizations from the user;
computer usable program code for generating, in real-time, a three-dimensional representation of the piece of jewelry based on the additional jewelry customizations that were received;
computer usable program code for rendering, in real-time, the three-dimensional representation of the piece of jewelry that was generated; and
computer usable program code for displaying in the graphical user interface the three-dimensional representation of the piece of jewelry that was rendered.

7. A server for providing jewelry configuration processes over a communications network, comprising:
a transmitter for transmitting machine readable code, which provides a graphical user interface, to a user over the communications network;
a receiver for receiving, via the graphical user interface, jewelry customizations from the user;
a processor configured for:
generating, in real-time, a three-dimensional representation of a piece of jewelry based on the jewelry customizations that were received; and
rendering, in real-time, the three-dimensional representation of the piece of jewelry that was generated; and
sending a command to the transmitter to transmit machine readable code, which displays in the graphical user interface the three-dimensional representation of the piece of jewelry that was rendered, to the user.
